(19) United States
(12) Patent Application Publication
(10) Pub. No.: US 2026/0168885 A1
(43) Pub. Date: Jun. 18, 2026

(54) TEST DEVICE FOR BUBBLE DAMAGE OF SEALING MATERIAL

(71) Applicant: Tsinghua University, Beijing (CN)

(72) Inventors: Fei Guo, Beijing (CN); Yijie Huang, Beijing (CN); Pengbing Wang, Beijing (CN)

(21) Appl. No.: 19/053,067

(22) Filed: Feb. 13, 2025

(30) Foreign Application Priority Data
Dec. 13, 2024 (CN) 2024118427414

(51) Int. Cl. G01M 13/005; G01B 5/12

(52) U.S. Cl. CPC G01M 13/005; G01B 5/12

(57) ABSTRACT

A test device for bubble damage of sealing material includes first radius measure members, first location measure members and second location measure members on a first housing along a circumferential direction. The first radius measure members may move along a height direction of the first housing, the first location measure members may move along a radial direction of the first housing, and the second location measure members may move along the height direction of the first housing. The device further includes a plurality of second radius measure members on a second housing along a circumferential direction. The second radius measure members may move along a radial direction of the second housing. A sample to be measured may be placed in the housings, and the device may be used to test for bubbles on a top surface or a side surface of the sample.

### PRIORITY CLAIM

This application claims the benefit of the filing date of Chinese Patent Application Serial No. CN2024118427414, filed Dec. 13, 2024, for “TEST DEVICE FOR BUBBLE DAMAGE OF SEALING MATERIAL,” the disclosure of which is hereby incorporated herein in its entirety by this reference.

### TECHNICAL FIELD

The present disclosure relates to the field of detection and provides a test device for bubble damage of sealing material.

### BACKGROUND

Seal rings play a vital role in various industrial fields and have main functions of preventing the leakage of fluids or gases and ensuring the performance of a seal system. Seal rings may be made of a variety of elastic materials such as rubber, polyurethane, silicone, etc., and material selection, structural design and size specifications of the seal rings will also vary according to different application environments. With suitable materials and effective sealing force, seal rings perform well in preventing liquid and gas leakage.

However, when the seal rings are involved in special working environments such as high-pressure hydrogen, a problem of hydrogen-induced bubbles in sealing materials becomes particularly prominent. Hydrogen-induced bubbles in sealing materials are formed by hydrogen atoms penetrating into the interior of the material and undergoing long-term exposure, which may cause cavities in part of the material to result in sealing failure and pose certain safety risks. This raises requirements for accurate measurement and evaluation of hydrogen-induced bubbles in sealing materials.

Traditional methods for measurement of hydrogen-induced bubbles mainly include optical microscopy, scanning electron microscopy (SEM) and X-ray tomography (XCT). Although these methods may accurately detect and analyze information such as sizes and locations of the hydrogen-induced bubbles, these methods are high relatively in cost, susceptible to influence of external environmental factors, and long in measurement period in practical applications, and thus they may not meet requirements for rapid response and efficient detection. Therefore, developing a method that is efficient, low-cost and accurate in measurement of the hydrogen-induced bubbles is of great significance for improving the performance and safety of sealing materials.

### BRIEF SUMMARY

An embodiment of the present disclosure provides a test device for bubble damage of sealing material to solve the defects that detection of hydrogen-induced bubbles is low in efficiency and high in cost in the related art.

An embodiment of the present disclosure provides a test device for bubble damage of sealing material, including:
a first housing, where a plurality of first radius measure members, a plurality of first location measure members and a plurality of second location measure members are provided at the first housing along a circumference direction of the first housing, the first radius measure members are suitable for moving along a height direction of the first housing, the first location measure members are suitable for moving along a radial direction of the first housing, and the second location measure members are suitable for moving along the height direction of the first housing; and
a second housing, where a plurality of second radius measure members are provided at the second housing along a circumference direction of the second housing, and the second radius measure members are suitable for moving along a radial direction of the second housing;
where in case that a sample to be measured is placed in the first housing and the second housing, the first radius measure members and the first location measure members are suitable for being tangent to edges of bubbles on a top surface of the sample to be measured, and the second radius measure members and the second location measure members are suitable for being tangent to edges of bubbles on a side surface of the sample to be measured.

According to an embodiment of the present disclosure, a side wall of the first housing is provided with slot holes, the slot holes penetrate through the side wall of the first housing along the radial direction of the first housing, two opposite side walls of the slot holes are provided with slide grooves along the circumference direction of the first housing and the first radius measure members are slidably connected to the slide grooves.

According to an embodiment of the present disclosure, the test device further includes a central circular ring, contact plates are hinged at the central circular ring, translation plates are hinged at ends of the contact plates away from the central circular ring, and the translation plates are slidably connected to the slide grooves.

According to an embodiment of the present disclosure, the first housing is provided with first opening holes, which communicate with the slot holes, along the height direction of the first housing, the first radius measure members are inserted into the first opening holes, and ends of the first radius measure members inserted into the first opening holes are connected to the translation plates.

According to an embodiment of the present disclosure, the slide grooves are arc-shaped to allow the translation plates to move along the height direction of the first housing.

According to an embodiment of the present disclosure, side walls of the slot holes facing the second housing are provided with guide grooves and the first location measure members are slidably connected to the guide grooves.

According to an embodiment of the present disclosure, the first housing is provided with second opening holes along the height direction of the first housing, and the second location measure members are inserted into the second opening holes.

According to an embodiment of the present disclosure, a side wall of the second housing is provided with a mount hole and the second radius measure members are inserted into the mount hole.

According to an embodiment of the present disclosure, two groups of mount holes are provided along the height direction of the second housing, and each group of mount holes are provided insertedly with the second radius measure members, and ends of the second radius measure members facing an inside of the second housing are connected to a synchronizing rod.

According to an embodiment of the present disclosure, a center of the first housing is provided with a third radius measure member, a bracket is connected to the first housing, and the third radius measure member is movably inserted into the bracket.

According to the test device for bubble damage of sealing material provided by the embodiment of the present disclosure, by allowing the first radius measure members, the first location measure members and the second location measure members on the first housing, and the second radius measure members on the second housing to be tangent to edges of the bubbles of the sample to be measured, the radius and location of the bubbles may be accurately measured to ensure the accuracy and reliability of the measurement. The test device may simultaneously measure the bubbles on the top and side surfaces of the sample to be measured, thereby providing comprehensive bubble detection capabilities. The first radius measure members and the first location measure members as well as the second radius measure members and the second location measure members may move in different directions, which increases the flexibility and adaptability of the device and enables the device to handle bubbles of various shapes and sizes. The measurement process may be greatly simplified and the detection efficiency may be improved since the first radius measure members, the first location measure members, the second radius measure members, and the second location measure members may be tangent to the edges of the bubbles. The test device for bubble damage of sealing material provided by the present disclosure has significant advantages in accuracy, versatility, adaptability and efficiency. Moreover, the test device may detect the position and radius of the bubbles at the top and side of the sample to be measured through a purely mechanical structure, and the design and maintenance cost thereof is low, and it provides an effective solution for the detection of hydrogen-induced bubbles.

### BRIEF DESCRIPTION OF THE DRAWINGS

To illustrate solutions of the present disclosure or in the related art more clearly, accompanying drawings that needs to be used in the description of the embodiments or the related art are briefly described below. The drawings described below are only some embodiments of the present disclosure. For those skilled in the art, other drawings may also be obtained based on these drawings without creative effort.

FIG. 1 is a schematic stereoscopic view of a test device for bubble damage of sealing material according to the present disclosure.

FIG. 2 is a schematic stereoscopic view of a test device for bubble damage of sealing material in which one of first radius measure members, first location measure members and second radius measure members are hidden according to the present disclosure.

FIG. 3 is a partial enlarged view of A shown in FIG. 2.

FIG. 4 is a partial enlarged view of B shown in FIG. 2.

FIG. 5 is a schematic top view of a test device for bubble damage of sealing material, according to the present disclosure;

FIG. 6 is a schematic cross-sectional view along a C-C direction shown in FIG. 5.

FIG. 7 is a partial enlarged view of D shown in FIG. 6.

### DETAILED DESCRIPTION

Implementations of the present disclosure are further described in detail below in conjunction with the drawings and embodiments. The following embodiments are intended to illustrate the present disclosure, but are not intended to limit the scope of the present disclosure.

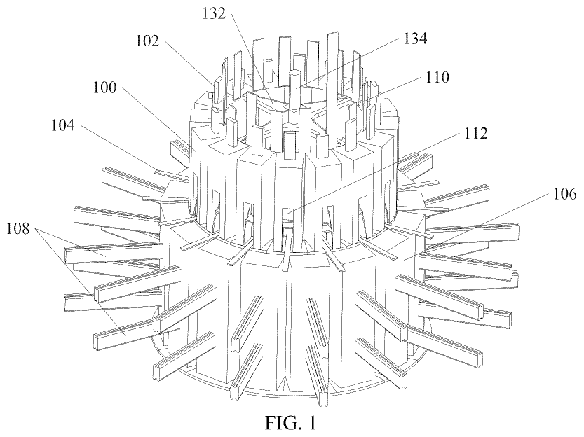

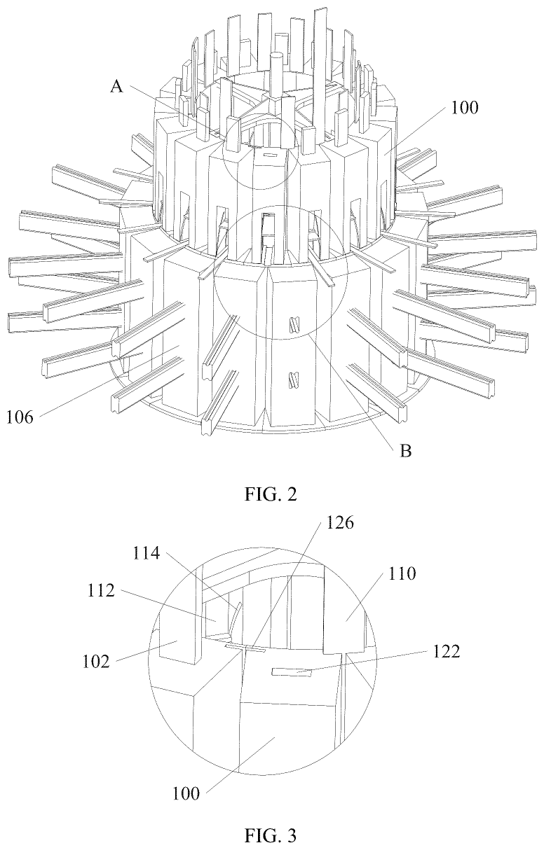

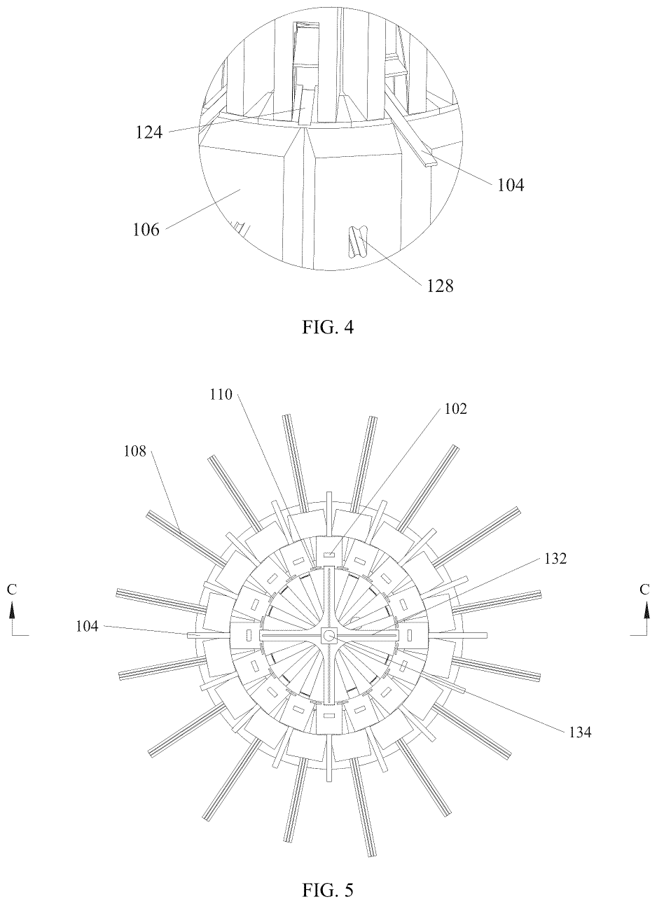

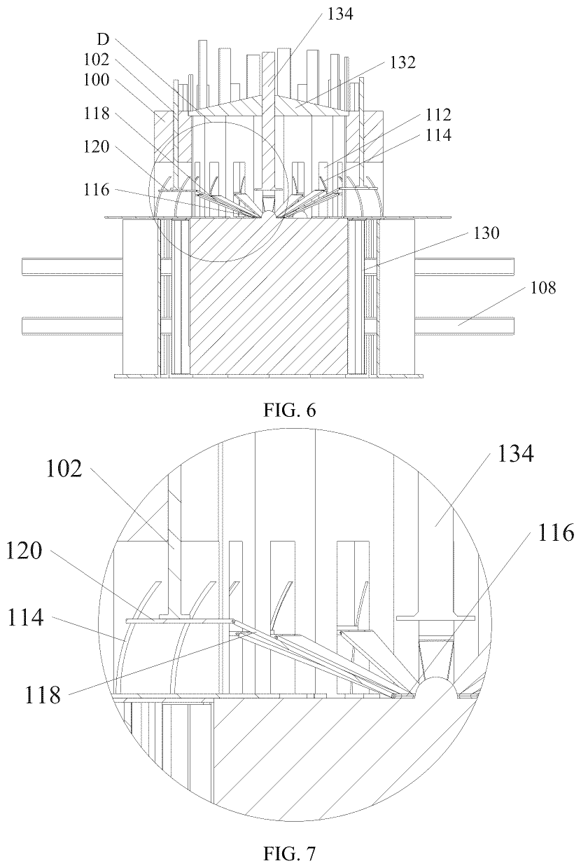

As shown in FIG. 1 to FIG. 7, an embodiment of the present disclosure provides a test device for bubble damage of sealing material, including:

a first housing 100, where a plurality of first radius measure members 102, a plurality of first location measure members 104 and a plurality of second location measure members 110 are provided at the first housing 100 along a circumference direction of the first housing 100, the first radius measure members 102 are suitable for moving along a height direction of the first housing, the first location measure members 104 are suitable for moving along a radial direction of the first housing, and the second location measure members 110 are suitable for moving along the height direction of the first housing; and

a second housing 106, where a plurality of second radius measure members 108 are provided at the second housing 106 along a circumference direction of the second housing 106, and the second radius measure members 108 are suitable for moving along a radial direction of the second housing 106;

where in case that a sample to be measured is placed in the first housing 100 and the second housing 106, the first radius measure members 102 and the first location measure members 104 are suitable for being tangent to edges of bubbles on a top surface of the sample to be measured, and the second radius measure members 108 and the second location measure members 110 are suitable for being tangent to edges of bubbles on a side surface of the sample to be measured.

The embodiment of the present disclosure provides a test device for bubble damage of sealing material, mainly consisting of the first housing 100 and the second housing 106. The two housings cooperate with each other in design and function to accurately measure hydrogen-induced bubbles in the sample to be measured.

The plurality of first radius measure members 102, the plurality of first location measure members 104 and the plurality of second location measure members 110 are provided at the first housing along a circumference direction of the first housing 100. The first radius measure members are designed to move along the height direction of the first housing 100, which means that the first radius measure members may move up and down to adapt to bubbles of different heights, the first location measure members 104 may move along the radial direction of the first housing 100, and the second location measure member 110 may move along the height direction of the first housing.

In the embodiment of the present disclosure, the number of the first radius measure members 102, the first location measure members 104 and the second location measure members 110 may be sixteen, respectively. That is, an angular interval between two adjacent first radius measure members 102 is 22.5 degrees, and an angular interval between two adjacent first location measure members 104 is 22.5 degrees, and an angular interval between two adjacent second location measure members 110 is 22.5 degrees.

The first location measure members 104 may move along the radial direction of the first housing 100 (i.e., move outwards or inwards) to more accurately position the location of the bubbles.

The plurality of second radius measure members 108 are provided along the circumference of the second housing 106. Unlike the measure members in the first housing 100, the second radius measure members 108 move along the radial direction of the second housing 106, which allows the second radius measure member 108 to be tangent to edges of the bubbles at sides of the sample to be measured.

In the embodiment of the present disclosure, the number of the second radius measure members 108 may also be sixteen. That is, an angular interval between two adjacent second radius measure members 108 is 22.5 degrees.

In addition, in order to avoid the inconvenience of reading of the first location measure members 104 and the second location measure members 110, the first location measure members 104 and the second location measure members 110 are arranged in a staggered manner.

Similarly, the first radius measure members 102 and the second radius measure members 108 are also arranged in a staggered manner. Moreover, the first location measure members 104 are arranged in the same manner as the first radius measure members 102, and the second location measure members 110 are arranged in the same manner as the second radius measure members 108.

When the sample to be measured is placed in the first housing 100 and the second housing 106, the first radius measure members 102 and the first location measure members 104 of the first housing 100 will be tangent to edges of bubbles on a top surface of the sample to be measured.

Simultaneously, the second radius measure members 108 of the second housing 106 and the second location measure members 110 of the first housing 100 will be tangent to edges of bubbles on a side surface of the sample to be measured.

Specifically, in actual use, the sample to be measured is placed in the first housing 100 and the second housing 106, the first housing 100 corresponds to a top plane of the sample to be measured, and the second housing 106 corresponds to an outer circumferential surface of a bottom cylinder of the sample to be measured.

When bubbles appear on the top plane of the sample to be measured, the bubbles on the top plane will lift up the first radius measure members 102, and a radius R1 of the bubbles appearing on the top plane may be obtained by direct reading or calculation. End edges of the first location measure members 104 abut against edges of the bubbles appearing on the top plane. A distance L1 between the edges of the bubbles and an outer wall of the first housing 100 may be read out through readings of the first location measure members 104. Since a distance L2 between the center of the top plane and the outer wall of the first housing 100 is known, a location of the bubbles appearing on the top plane relative to a center of the top plane may be obtained as L2-L1-R1.

When bubbles appear on a side of the sample to be measured, the bubbles on the side will lift up the second radius measure members 108, and a radius R2 of the bubbles appearing on the side may be obtained by direct reading. End edges of the second location measure members 110 then abut against edges of the bubbles appearing on the side. A distance L3 between the edges of the bubbles and a top plane of the first housing 100 may be read out through readings of the second location measure members 110. Since a distance L4 between a top of the sample to be measured and a top of the first housing 100 is known, a location of the bubbles appearing on the side of the sample to be measured relative to a top of the sample to be measured may be obtained as L3-L4-R2.

By allowing the first radius measure members 102, the first location measure members 104 and the second location measure members 110 on the first housing 100 and the second radius measure members 108 on the second housing 106 to be tangent to edges of the bubbles of the sample to be measured, the radius and location of the bubbles may be accurately measured to ensure the accuracy and reliability of the measurement. The test device may simultaneously measure the bubbles on the top and side surfaces of the sample to be measured, thereby providing comprehensive bubble detection capabilities. The first radius measure members 102 and the first location measure members 104 as well as the second radius measure members 108 and the second location measure members 110 may move in different directions, which increases the flexibility and adaptability of the device and enables the device to handle bubbles of various shapes and sizes. The measurement process may be greatly simplified and the detection efficiency may be improved since the first radius measure members 102, the first location measure members 104, the second radius measure members 108, and the second location measure members 110 may be tangent to the edges of the bubbles. The test device for bubble damage of sealing material provided by the present disclosure has significant advantages in accuracy, versatility, adaptability and efficiency. Moreover, the test device may detect the position and radius of the bubbles at the top and side of the sample to be measured through a purely mechanical structure, and the design and maintenance cost thereof is low, and it provides an effective solution for the detection of hydrogen-induced bubbles.

According to an embodiment of the present disclosure, a side wall of the first housing 100 is provided with slot holes 112, the slot holes 112 penetrate through the side wall of the first housing 100 along the radial direction of the first housing 100, two opposite side walls of the slot holes 112 are provided with slide grooves 114 along the circumference direction of the first housing 100, and the first radius measure members 102 are slidably connected to the slide grooves 114.

In an embodiment of the present disclosure, the first housing 100 is a structure having a side wall, and the side wall is provided with an slot hole 112. The slot hole 112 penetrates through the side wall along the radial direction of the first housing 100, which means that the slot hole 112 extends from an outer surface to the opposite inner surface. In addition, two opposite side walls of the slot holes 112 are provided with slide grooves 114 along the circumference direction of the first housing 100 (i.e., the circumferential direction around the housing).

The first radius measure members 102 are slidably connected to the slide grooves 114. It means that the first radius measure members 102 may slide in a certain direction in the slide grooves 114, thereby accurately measure or adjust a certain space or structure inside the housing.

By providing the slot holes 112 and the slide grooves 114 on the side wall of the housing, and the first radius measure members 102 slidably connected to the slide grooves 114, the device may flexibly adjust or measure a specific space or structure inside the housing. This design provides greater operating space and convenience. The design of slidable connection between the slide grooves 114 and the first radius measure members 102 helps to achieve high-precision measurement and adjustment. Since the first radius measure members 102 may move smoothly in the slide grooves 114, the location of the first radius measure members 102 may be very accurately controlled, thereby ensuring the accuracy of measurement or adjustment. This design also enhances the adaptability of the device. Different measurement or adjustment requirements may be met by simply sliding the first radius measure members 102 without replacing the entire housing or making complex adjustments. This design of slidable connection greatly simplifies the operation process compared with the traditional fixed measurement or adjustment method. Users may achieve the required measurement or adjustment by simply sliding the first radius measure members 102 without using additional tools or performing complex operations.

According to an embodiment of the present disclosure, the test device further includes a central circular ring 116, contact plates 118 are hinged at the central circular ring 116, translation plates 120 are hinged at ends of the contact plates 118 away from the central circular ring 116, and the translation plates 120 are slidably connected to the slide grooves 114.

In an embodiment of the present disclosure, a central circular ring 116, contact plates 118 and translation plates 120 associated with the central circular ring 116 are additionally added. This design is intended to further improve the accuracy and flexibility of measurement and adjustment.

The central circular ring 116 is located inside the first housing 100, and the central circular ring 116, serving as a central support point of the entire new structure, provides a stable connection foundation for the subsequent contact plates 118 and translation plates 120.

An end of each contact plate 118 is hinged to the central circular ring 116, and the contact plate 118 may rotate around a certain axis.

An end of each translation plate 120 is hinged to the end of the contact plate 118 away from the central circular ring 116, and another end of each translation plate 120 is slidably connected to the slide grooves 114 mentioned above. This design allows the translation plates 120 to rotate around the hinge point between the contact plates 118 and the central circular ring 116, and to translate along the slide grooves 114.

The present embodiment further improves the flexibility of the device by introducing the structure of the central circular ring 116, the contact plates 118 and the translation plates 120. The contact plates 118 and the translation plates 120 may move around the central circular ring 116 and along the slide grooves 114, respectively, thereby performing more diverse ways of measurement and adjustment. Contact points with the sample to be measured or other structures in the housing may be more accurately located and adjusted since the contact plates 118 and the translation plates 120 may rotate and translate respectively. This design helps to reduce errors and improve the accuracy of measurement. The introduction of the new structure makes the operation process smoother and more efficient. Users may quickly achieve the required measurement or adjustment by adjusting the position and angle of the contact plates 118 and the translation plates 120 without complicated operations or adjustments. This design further enhances the adaptability of the device. The device may meet the requirements by adjusting the position and angle of the contact plates 118 and the translation plates 120 no matter whether samples of different shapes, sizes or positions are to be measured, or needs of different structures in the housing are to be faced.

According to an embodiment of the present disclosure, the first housing 100 is provided with first opening holes 122, which communicate with the slot holes, along the height direction of the first housing 100, the first radius measure members 102 are inserted into the first opening holes 122, and ends of the first radius measure members 102 inserted into the first opening holes 122 are connected to the translation plates 120.

In an embodiment of the present disclosure, in order to further enhance the practicality of the structure and the flexibility of measurement and adjustment, the first housing 100 is additionally improved in design. Specifically, a side wall of the first housing 100 is provided with first opening holes 122, which communicate with the slot holes 112, along the height direction of the first housing 100 (i.e., perpendicular to the bottom surface of the first housing). The design of the first opening holes 122 allows the first radius measure members 102 to not only slide in the slide grooves 114, but also be inserted and connected to the translation plates 120 from the outside of the housing through the first opening hole 122.

The first opening holes 122 are openings located on the side wall of the first housing 100, which extends along the height direction of the housing and communicates with the slot holes 112 mentioned above. This design allows the first radius measure members 102 to be easily inserted into the slot holes 112 and the slide grooves 114 from the outside of the housing without complicated internal assembly.

Ends of the first radius measure members 102 are designed to be inserted into the first opening holes 122, and will be connected to the translation plates 120 once being inserted. This connection mode may be direct (for example, through fasteners such as bolts and pins) or indirect (for example, through some kind of connectors or intermediate members). In either case, it is ensured that the first radius measure members 102 may be smoothly and firmly connected to the translation plates 120, thereby achieving accurate measurement and adjustment.

By the design of the first opening holes 122, users may easily insert and connect the first radius measure members 102 to the translation plates 120 from the outside of the housing, which greatly improves the practicality and ease of use of the device. The design of the first opening holes 122 allows the first radius measure members 102 to be moved and adjusted in multiple directions, including sliding along the slide grooves 114 and inserting/pulling out in the height direction. This multi-dimensional adjusting capability enables the device to adapt to more diverse measurement and adjustment requirements. Compared with the traditional internal assembly method, the assembly process is greatly simplified by the design of inserting the first radius measure members 102 from the outside through the first opening holes 122 and connecting the first radius measure members 102 to the translation plate 120. It not only saves time and cost, but also reduces the error rate during the assembly process. It may ensure higher accuracy and stability during the measurement and adjustment process since the first radius measure members 102 may be smoothly and firmly connected to the translation plates 120.

According to an embodiment of the present disclosure, the slide grooves 114 are arc-shaped to allow the translation plates 120 to move along the height direction of the first housing 100.

According to an embodiment of the present disclosure, the slide grooves 114 are designed to be arc-shaped, and this design is intended to change the movement trajectories of the translation plates 120 such that the translation plates 120 can only move along the height direction of the first housing 100. This change not only enhances the functionality of the device, but also improves its measurement accuracy and adjustment flexibility.

Traditional slide grooves 114 are often linear, while the slide grooves 114 in this embodiment are designed to be arc-shaped. This design enables the translation plates 120 to move along a curved trajectory when sliding along the slide grooves 114, rather than a simple linear motion.

Since the translation plates 120 are connected to the contact plates 118, and the length of the contact plates 118 is fixed, the contact plates 118 are lifted up when bubbles appear on the top plane of the sample to be measured, and movement trajectories of the translation plates 120 are arc-shaped. By configuring the slide grooves 114 to be arc-shaped, the translation plates 120 will naturally move along the height direction of the first housing 100 when the translation plates 120 slide along the slide grooves 114. This change in movement trajectory enables the translation plates 120 to more accurately locate and adjust contact points with the sample to be measured or other structures in the housing. The design of the arc-shaped slide groove 114 greatly enhances the flexibility of measurement and adjustment.

Users may quickly obtain the required measurement or adjustment by adjusting locations of the translation plates 120 in the arc-shaped slide grooves 114 without complicated operations or adjustments. The design of the arc-shaped slide grooves 114 enables the translation plates 120 to move more accurately along the height direction of the first housing 100, thereby improving the accuracy of the measurement. This design helps to reduce errors and improve the accuracy of measurement. The device may more flexibly adapt to the needs of samples to be measured or other structures in the housing of different shapes, sizes or locations, since the translation plates 120 may move along the arc-shaped slide grooves 114. The design of the arc-shaped slide grooves 114 makes the operation process smoother and more efficient. Users may quickly obtain the required measurement or adjustment by simply adjusting locations of the translation plates 120 in the arc-shaped slide grooves 114 without complicated operations or adjustments. This design not only improves the practicality and flexibility of the device, but also provides users with a more convenient and efficient measurement and adjustment experience. The users may complete measurement and adjustment tasks more easily, thereby improving work efficiency and satisfaction.

In an embodiment of the present disclosure, since the contact plates 118 and the translation plates 120 are introduced, the radius of the bubbles on the top plane of the sample to be measured may be calculated as follows:

$$θ \approx tan θ = \frac{h}{L 6}$$

$$\frac{R}{L 6 - L 5 - x} = θ = \frac{h}{L 6}$$

$$R = \frac{hL 6 - hL 5}{L 6 + h}$$

$$Y = L 5 + x$$

where a reading of each first radius measure member 102 is h, a reading of each first location measure member 104 is L5, a length of each contact plate 118 is L6, a radius of the bubbles on the top of the sample to be measured is R, a distance between the bubble on the top of the sample to be measured and a center of the top plane of the sample to be measured is Y, and an angle between each contact plate 118 and the top plane of the sample to be measured is θ.

According to an embodiment of the present disclosure, side walls of the slot holes 112 facing the second housing 106 are provided with guide grooves 124, and the first location measure members 104 are slidably connected to the guide grooves 124.

In an embodiment of the present disclosure, the slot holes 112 not only communicate with the slide grooves 114, but also are additionally provided with the guide grooves 124 on the side wall of the slot holes 112 facing the second housing 106. This design is intended to enable the first location measure members 104 to slide in the guide grooves 124, to accurately measure a specific position inside or outside the housing.

The guide grooves 124 are provided along the side walls of the slot holes 112 facing the second housing 106. The design of the guide grooves 124 allows the first location measure members 104 to slide therein to accurately measure a specific position inside or outside the housing.

The first location measure members 104 are designed to be slidably connected in the guide grooves 124. This connection mode may be direct (for example, through a slide rail, a slider, etc.) or indirect (for example, through some kind of connectors or intermediate members). In either case, it ensures that the first location measure members 104 may slide smoothly and firmly in the guide grooves 124.

In the present disclosure, a new measurement dimension is added by introducing the design of the guide grooves 124 and the first location measure members 104. This enables the device to more comprehensively measure the spatial dimensions and positional relationships of a specific position inside or outside the housing. It may ensure higher accuracy and stability during the measurement process since the first location measure members 104 may slide smoothly and firmly in the guide grooves 124. This design helps to reduce errors and improve the accuracy of measurement. The design of the guide grooves 124 and the first location measure members 104 makes the measurement process more flexible and efficient. Users may quickly obtain the required measurement by adjusting locations of the first location measure members 104 in the guide grooves 124 without complicated operations or adjustments. This design not only improves the measurement capability of the device, but also adds more functionality to the device. For example, the device may accurately measure and adjust multiple positions inside or outside the housing by combined use of the slide grooves 114 with the guide grooves 124.

According to an embodiment of the present disclosure, the first housing 100 is provided with second opening holes 126 along the height direction of the first housing 100, and the second location measure members 110 are inserted into the second opening holes 126.

In an embodiment of the present disclosure, in order to further enhance the measurement function and flexibility of the device, the first housing 100 is provided with second opening holes 126 along the height direction of the first housing 100. The design of this second opening holes 126 allows the second location measure members 110 to be inserted into the housing from the outside of the housing to accurately measure the housing or the structure associated with the housing.

The second opening holes 126 are openings located on the side wall or top/bottom of the first housing 100, and extend along the height direction of the first housing. This design of the second opening holes 126 allows the second location measure members 110 to be easily inserted into the inside of the housing from the outside of the housing without complicated internal assembly.

The second location measure members 110 are designed to be insertable into the second opening holes 126, and they may contact the inside of the housing or the structure associated therewith to perform accurate measurement once being inserted. This contact may be direct (for example, through contact between ends of the measure members and a surface to be measured) or indirect (for example, through some kind of measure probes or sensors).

The measurement function of the device may be further enhanced in the present disclosure by introducing the design of the second opening holes 126 and the second location measure members 110. Users may obtain more comprehensive size and location information by accurately measuring the inside of the housing or the structure associated with the housing through the second location measure members 110. The design of the second opening holes 126 allows the second location measure members 110 to be inserted into and pulled out from the outside of the housing, which enables the device to adapt to different measurement requirements more flexibly. Users may select measure members of different sizes or types as needed to meet specific measurement requirements. Compared with the traditional internal measurement method, the measurement process is greatly simplified by the design of inserting the second location measure members 110 from the outside through the second opening holes 126. It not only saves time and cost, but also reduces the error rate during the measurement process. This design not only improves the measurement accuracy and flexibility of the device, but also provides users with a more convenient and efficient measurement experience. The users may complete measurement tasks more easily, thereby improving work efficiency and satisfaction.

According to an embodiment of the present disclosure, a side wall of the second housing 106 is provided with mount holes 128 and the second radius measure members 108 are inserted into the mount holes 128.

In an embodiment of the present disclosure, the side wall of the second housing 106 is provided with a mount hole 128, and the design of the mount hole 128 allows the second radius measure members 108 to be inserted into the inside of the housing or the structure associated therewith from the outside of the housing to accurately measure these structures.

The mount hole 128 is located on the side wall of the second housing 106, and the location and size of the mount hole 128 are precisely designed to ensure that the second radius measure members 108 may be smoothly and firmly inserted therein. The mount hole 128 not only provides a convenient insertion channel for the measure members, but also ensures stability and accuracy during the measurement process.

The second radius measure members 108 are designed as being insert insertable into the mount hole 128, and they may contact the inside of the housing or the structure associated therewith to perform accurate radius measurement once being inserted. This contact may be direct (for example, through contact between ends of the measure members and a surface to be measured) or indirect (for example, through some kind of measure probes or sensors).

Accurate radius measurement of the inside of the housing or the structure associated therewith may be achieved in the present disclosure by introducing the design of the mount hole 128 and the second radius measure members 108. This design helps to reduce errors and improve the accuracy of measurement. The design of the mount hole 128 allows the second radius measure members 108 to be inserted into and pulled out from the outside of the housing, which enables the device to adapt to different measurement requirement more flexibly. Users may select measure members of different sizes or types as needed to meet specific measurement requirements. Compared with the traditional internal measurement method, the measurement process is greatly simplified by the design of inserting the second radius measure members 108 from the outside through the mount hole 128. Users may easily complete the measurement task without disassembling the housing or performing complex internal assembly. This design not only improves the measurement accuracy and flexibility of the device, but also provides users with a more convenient and efficient measurement experience. The users may complete measurement tasks more easily, thereby improving work efficiency and satisfaction.

According to an embodiment of the present disclosure, two groups of mount holes 128 are provided along the height direction of the second housing 106, and each group of mount holes 128 are provided insertedly with the second radius measure members 108, and the ends of the second radius measure members 108 facing an inside of the second housing 106 are connected to a synchronizing rod 130.

In an embodiment of the present disclosure, two groups of mount holes 128 are provided at the side wall of the second housing 106 along the height direction of the second housing 106. Each group of mount holes 128 are provided insertedly with one second radius measure member 108, and the ends of these measure members facing the inside of the second housing 106 are all connected to a synchronizing rod 130. This design is intended to improve the accuracy and efficiency of measurement, while enhancing the flexibility and practicality of the device.

The side wall of the second housing 106 is provided with two groups of mount holes 128 along the height direction thereof, and each group of mount holes 128 are located at positions of different heights. This design allows the users to measure the radius at different heights, thereby obtaining more comprehensive dimensional information.

Each group of mount holes 128 are provided insertedly with one second radius measure member 108. These measure members may slide or adjust along the direction of the mount holes 128 to meet different measurement requirements. Simultaneously, the movement stability of the second radius measure members 108 is improved.

One end of each second radius measure member 108 facing the inside of the second housing 106 is connected to a synchronizing rod 130. The function of these synchronizing rods 130 is to maintain the synchronous movement between two second radius measure members 108 at upper and lower positions during the measurement process, thereby ensuring the accuracy and consistency of the measurement. By the connection of the synchronizing rods 130, when one of the second radius measure members 108 moves, another second radius measure member 108 will also move accordingly to maintain the relative position relationship between the two second radius measure members.

By introducing the design of the synchronizing rods 130, the present disclosure may ensure the synchronous movement of the two second radius measure members 108 during the measurement process, and the accuracy of the measurement is greatly improved. This design helps to reduce errors and improve the reliability of measurement. Users may perform simultaneous measurements at different height positions to greatly improve the measurement efficiency since two groups of mount holes 128 and two second radius measure members 108 are provided. This design enables the users to obtain the required dimensional information more quickly and improves work efficiency. Compared with a traditional single-point measurement method, the present disclosure realizes multi-point synchronous measurement by introducing the design of two groups of mount holes 128 and synchronizing rods 130. This not only simplifies the measurement process, but also reduces the complexity and error rate in the measurement process. This design not only improves the measurement accuracy and efficiency of the device, but also provides users with a more convenient and efficient measurement experience. Users may complete the measurement task more easily and obtain more comprehensive dimensional information simultaneously, thereby improving work satisfaction and efficiency.

According to an embodiment of the present disclosure, a center of the first housing 100 is provided with a third radius measure member 134, a bracket 132 is connected to the first housing 100, and the third radius measure member 134 is movably inserted into the bracket 132.

In an embodiment of the present disclosure, a bracket 132 for mounting the third radius measure member 134 is designed at the center position of the first housing 100. The bracket 132 not only allows the third radius measure member 134 to perform accurate radius measurement at the center of the first housing 100, but also enables the measure member to be flexibly moved and adjusted.

The center of the first housing 100 is designed to accommodate and mount the bracket 132, which is used to mount and support the third radius measure member 134. The third radius measure member 134 is specially designed to perform accurate radius measurement of the bubble at the center of the top of the sample to be measured, and a size and a shape of the third radius measure member 134 match the center of the first housing 100.

In order to enhance the flexibility and practicality of the third radius measure member 134, a bracket 132 is further connected to the first housing 100. This bracket 132 is designed to stably support the third radius measure member 134 and allow the third radius measure member 134 to move within a certain range on the bracket 132. This design allows users to adjust the position and angle of the third radius measure member 134 as needed to meet different measurement requirements.

The third radius measure member 134 is designed to be movably inserted into the bracket 132. This means that the third radius measure member 134 may not only perform translational movement on the bracket 132, but also perform movements such as rotation or tilt. This movement enables the third radius measure member 134 to adapt to different measurement scenarios and objects more flexibly. In actual detection, a radius of the bubbles at the center of the top plane of the sample to be measured may be measured by direct reading.

The stability and accuracy during the measurement process may be ensured in the present disclosure by providing the third radius measure member 134 at the center of the first housing 100 and connecting a stable bracket 132. This design helps to reduce errors and improve the reliability of measurement. The movable design of the bracket 132 and the third radius measure member 134 enables the users to adjust the position and angle of the measure member as needed. This flexibility not only improves the efficiency of measurement, but also enables the device to be more widely used in different measurement scenarios and objects. Compared with the traditional fixed measurement method, the present disclosure optimizes the measurement process by introducing the movable design of the bracket 132 and the third radius measure member 134. Users may complete measurement tasks more easily and obtain more accurate measurement results.

Finally, it should be noted that the above embodiments are only used to explain the solutions of the present disclosure, and are not limited thereto. Although the present disclosure is described in detail with reference to the foregoing embodiments, it should be understood by those skilled in the art that they may still modify the solutions described in the foregoing embodiments and make equivalent replacements to a part of the features and these modifications and substitutions do not depart from the scope of the solutions of the embodiments of the present disclosure.

What is claimed is:

1. A test device for bubble damage of sealing material, comprising:
a first housing, wherein a plurality of first radius measure members, a plurality of first location measure members and a plurality of second location measure members are provided at the first housing along a circumference direction of the first housing, the first radius measure members are suitable for moving along a height direction of the first housing, the first location measure members are suitable for moving along a radial direction of the first housing, and the second location measure members are suitable for moving along the height direction of the first housing; and
a second housing, wherein a plurality of second radius measure members are provided at the second housing along a circumference direction of the second housing, and the second radius measure members are suitable for moving along a radial direction of the second housing;
wherein in case that a sample to be measured is placed in the first housing and the second housing, the first radius measure members and the first location measure members are suitable for being tangent to edges of bubbles on a top surface of the sample to be measured, and the second radius measure members and the second location measure members are suitable for being tangent to edges of bubbles on a side surface of the sample to be measured.

2. The test device for bubble damage of sealing material of claim 1, wherein a side wall of the first housing is provided with slot holes, the slot holes penetrate through the side wall of the first housing along the radial direction of the first housing, two opposite side walls of the slot holes are provided with slide grooves along the circumference direction of the first housing, and the first radius measure members are slidably connected to the slide grooves.

3. The test device for bubble damage of sealing material of claim 2, further comprising: a central circular ring, contact plates being hinged at the central circular ring, and translation plates being hinged at ends of the contact plates away from the central circular ring, wherein the translation plates are slidably connected to the slide grooves.

4. The test device for bubble damage of sealing material of claim 3, wherein the first housing is provided with first opening holes, which communicate with the slot holes, along the height direction of the first housing, the first radius measure members are inserted into the first opening holes, and ends of the first radius measure members (102) inserted into the first opening holes are connected to the translation plates.

5. The test device for bubble damage of sealing material of claim 3, wherein the slide grooves are arc-shaped to allow the translation plates to move along the height direction of the first housing.

6. The test device for bubble damage of sealing material of claim 2, wherein side walls of the slot holes facing the second housing are provided with guide grooves and the first location measure members are slidably connected to the guide grooves.

7. The test device for bubble damage of sealing material of claim 1, wherein the first housing is provided with second opening holes along the height direction of the first housing, and the second location measure members are inserted into the second opening holes.

8. The test device for bubble damage of sealing material of claim 2, wherein the first housing is provided with second opening holes along the height direction of the first housing, and the second location measure members are inserted into the second opening holes.

9. The test device for bubble damage of sealing material of claim 3, wherein the first housing is provided with second opening holes along the height direction of the first housing, and the second location measure members are inserted into the second opening holes.

10. The test device for bubble damage of sealing material of claim 4, wherein the first housing is provided with second opening holes along the height direction of the first housing, and the second location measure members are inserted into the second opening holes.

11. The test device for bubble damage of sealing material of claim 5, wherein the first housing is provided with second opening holes along the height direction of the first housing, and the second location measure members are inserted into the second opening holes.

12. The test device for bubble damage of sealing material of claim 6, wherein the first housing is provided with second opening holes along the height direction of the first housing, and the second location measure members are inserted into the second opening holes.

13. The test device for bubble damage of sealing material of claim 1, wherein a side wall of the second housing is provided with a mount hole, and the second radius measure members are inserted into the mount hole.

14. The test device for bubble damage of sealing material of claim 2, wherein a side wall of the second housing is provided with a mount hole, and the second radius measure members are inserted into the mount hole.

15. The test device for bubble damage of sealing material of claim 3, wherein a side wall of the second housing is provided with a mount hole, and the second radius measure members are inserted into the mount hole.

16. The test device for bubble damage of sealing material of claim 4, wherein a side wall of the second housing is provided with a mount hole, and the second radius measure members are inserted into the mount hole.

17. The test device for bubble damage of sealing material of claim 5, wherein a side wall of the second housing is provided with a mount hole, and the second radius measure members are inserted into the mount hole.

18. The test device for bubble damage of sealing material of claim 6, wherein a side wall of the second housing is provided with a mount hole, and the second radius measure members are inserted into the mount hole.

19. The test device for bubble damage of sealing material of claim 13, wherein two groups of mount holes are provided along the height direction of the second housing, each group of mount holes are provided insertedly with the second radius measure members, and ends of the second radius measure members facing an inside of the second housing are connected to a synchronizing rod.

20. The test device for bubble damage of sealing material of claim 1, wherein a center of the first housing is provided with a third radius measure member, a bracket is connected to the first housing, and the third radius measure member is movably inserted into the bracket.
